(19) United States
(12) Patent Application Publication
(10) Pub. No.: US 2006/0139020 A1
(43) Pub. Date: Jun. 29, 2006

(54) Simple partial switching power factor correction circuit

(75) Inventors: Peter Wood, Rolling Hills Estates, CA (US); Maurizio Salato, Torrance, CA (US)

Correspondence Address: OSTROLENK FABER GERB & SOFFEN, 1180 AVENUE OF THE AMERICAS, NEW YORK, NY, 100368403, US

(73) Assignee: International Rectifier Corporation

(21) Appl. No.: 11/302,544

(22) Filed: Dec. 13, 2005

Related U.S. Application Data
(60) Provisional application No. 60/635,921, filed on Dec. 14, 2004.

(51) Int. Cl. G05F 1/40; G05F 1/56

(52) U.S. Cl. 323/283

(57) ABSTRACT

A boost type power supply circuit for providing a DC output voltage comprising first and second semiconductor switches coupled between respective input lines and a common connection, an AC input voltage from an AC source being supplied across the input lines; first and second diodes coupled in series with respective ones of the switches; third and fourth diodes coupled across respective ones of the switches in a free-wheeling relationship with the switches, an inductance coupled in at least one of the input lines; a controller for controlling the conduction times of the switches by providing a pulse width and phase modulated control signal to each of the switches; whereby the controller turns on at least one of the switches during a positive half cycle of the AC voltage to allow energy storage in the inductance and turns off the at least one switch to allow the energy stored in the inductance to be supplied to an attached load through one of the first and second diodes and one of the third or fourth diodes; and the controller turns on at least one of the switches during a negative half cycle of the AC voltage to allow energy storage in the inductance and turns off the at least one switch to allow the energy stored in the inductance to be supplied to the attached load through one of the first and second diodes and one of the third and fourth diodes; and wherein the controller determines an on-time and an off-time of a pulse of the pulse width modulated control signal during each half cycle of the AC voltage based on at least one input without requiring sensing of the input current from the AC source; the on-time and off-time of the pulse being controlled to regulate said output voltage and to provide power factor correction of said AC input voltage.

### CROSS-REFERENCE TO RELATED APPLICATIONS

The present application claims the benefit and priority of U.S. Provisional Application No. 60/635,921 filed Dec. 14, 2004 and entitled PHASE AND PULSE WIDTH MODULATION CONTROL FOR SIMPLE PARTIAL SWITCHING (SPS) POWER FACTOR CORRECTION (PFC) CIRCUITS, the entire disclosure of which is incorporated by reference herein.

### BACKGROUND OF THE INVENTION

The present application relates to power supplies with active power factor correction circuits and in particular, simple partial switching (SPS) power factor correction circuits. Even more particularly, the present invention relates to such a power factor correction circuit based on output voltage feedback and discloses an embodiment having a digital controller.

The motor control market, including electric appliances such as air-conditioners, requires significant power from the AC line mains, for example, for air conditioners on the order of 300 to 2500 kw. The need for continuous service at these power levels from domestic outlets requires high power factor in order not to overload the local power network and to provide compliance with standards such as IEC 61000-3-2 Class A standard for harmonic current emissions.

Cost and size issues are driving the choice of active power factor correction circuits toward low-cost, reduced performance systems like the SPS (simple partial switching) topology, known in the literature since 1992. These circuits typically rely on input current feedback to provide power factor correction.

### SUMMARY OF THE INVENTION

An object of the present invention is to provide a converter circuit using the SPS topology which does not require input current feedback for PFC.

Another object of the present invention is to provide a digital control of the SPS PFC control.

It is also an object of the present invention to improve upon the existing simple partial switching power factor correction by providing a digital control for the SPS control function and in particular, a controller which uses a single pulse control to control the power factor correction function.

In accordance with the invention, a boost type power supply circuit for providing a DC output voltage is provided comprising first and second semiconductor switches coupled between respective input lines and a common connection, an AC input voltage from an AC source being supplied across the input lines; first and second diodes coupled in series with respective ones of the switches; third and fourth diodes coupled across respective ones of the switches in a free-wheeling relationship with the switches, an inductance coupled in at least one of the input lines; a controller for controlling the conduction times of the switches by providing a pulse width and phase modulated control signal to each of the switches; whereby the controller turns on at least one of the switches during a positive half cycle of the AC voltage to allow energy storage in the inductance and turns off the at least one switch to allow the energy stored in the inductance to be supplied to an attached load through one of the first and second diodes and one of the third and fourth diodes; and the controller turns on at least one of the switches during a negative half cycle of the AC voltage to allow energy storage in the inductance and turns off the at least one switch to allow the energy stored in the inductance to be supplied to the attached load through one of the first and second diodes and one of the third and fourth diodes; and wherein the controller determines an on-time and an off-time of a pulse of the pulse width modulated control signal during each half cycle of the AC voltage based on at least one input without requiring sensing of input current from the AC source; the on-time and off-time of the pulse being controlled to regulate said output voltage and to provide power factor correction of said AC input voltage.

### BRIEF DESCRIPTION OF THE DRAWINGS

The invention will now be described in greater detail in the following detailed description with reference to the drawings in which

FIG. 1 shows a simplified schematic for a bridgeless boost converter with SPS power factor correction according to the invention;

FIG. 2 shows a circuit diagram of a bridgeless boost converter with PFC according to the present invention incorporating digital control together with a waveform showing the positive AC half cycle;

FIG. 3 shows the timing diagram of a control pulse provided to the switches of the circuit of FIG. 2;

FIG. 3A shows exemplary low power waveforms for the input current I and AC half cycle voltage V;

FIG. 3B shows exemplary high power current I and AC voltage waveforms;

FIG. 4 shows the control system structure for the digital control of the circuit of FIG. 2;

FIG. 5 shows the firmware main loop flow chart for the circuit of FIG. 2;

FIGS. 6A and 6B show the firmware subroutine flow charts for the circuit of FIG. 2;

FIG. 7 shows power factor as a function of the on times and off times for the pulse provided to the switches;

FIG. 8 shows the input RMS current as a function of the on times and off times of the pulse provided to the switches;

FIG. 9 shows the optimized trend for on-time and off-time for the pulses provided to the switches versus input current for the circuit of FIG. 2;

FIGS. 10-18 show input waveforms and power parameters for the circuit of FIG. 2 as follows:

FIG. 10 Vᵢₙ=180 Vᵣₘₛ Pᵢₙ=190 W

FIG. 11 Vᵢₙ=180 Vᵣₘₛ Pᵢₙ=700 W

FIG. 12 Vᵢₙ=180Vᵣₘₛ Pᵢₙ=1380 W

FIG. 13 Vᵢₙ=200 Vᵣₘₛ Pᵢₙ=170 W

FIG. 14 Vᵢₙ=200 Vᵣₘₛ Pᵢₙ=690 W

FIG. 15 Vᵢₙ=200 Vᵣₘₛ Pᵢₙ=1350 W

FIG. 16 Vᵢₙ=230 Vᵣₘₛ Pᵢₙ=185 W

FIG. 17 Vᵢₙ=230 Vᵣₘₛ Pᵢₙ=675 W and

FIG. 18 Vᵢₙ=230Vᵣₘₛ Pᵢₙ=1350 W; and

FIG. 19 shows a summary chart of SPS digital control showing power factor versus active input power at different input voltages (180 Vrms, 200 Vrms and 230 Vrms) with an output voltage of 280 volts DC and an input inductance of 40 millihenries.

### DETAILED DESCRIPTION

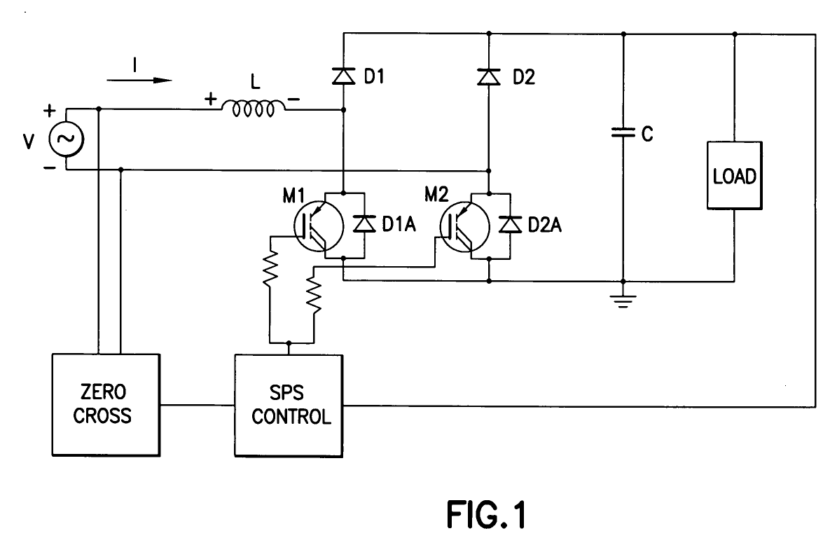

With reference now to FIG. 1, this shows a system schematic of a bridgeless boost power supply with SPS power factor correction according to the invention. The circuit is simpler than traditional boost type converter circuits with PFC which require an input rectifying bridge to convert the AC main current into a DC current, and a PFC switch coupled between the output of the input inductor and ground. The standard power factor correction circuit has higher conduction losses due to the diode bridge and has redundant rectification in that rectification occurs both in the diode bridge and in the boost diode.

In contrast, the circuit of FIG. 1 is simpler and is often called a bridgeless boost circuit with PFC. There are only four diodes, not five, and if the transistor switches are implemented with FETs, two of the diodes can be eliminated because of the presence of the body diodes of the FETs.

In the circuit shown in FIG. 1, IGBTs M1 and M2 are employed together with diodes D1 and D2 and D1A and D2A. If M1 and M2 are FETs, diodes D1A and D2A can be dispensed with and would be the body diodes of the FETs.

The circuit shown in FIG. 1 operates in the following way: For the positive AC input half cycle, initially, the switch M1 is turned on to allow current to flow through the inductor L thereby storing energy in the inductor L. The current path is through the switch M1 which is turned on and then through the diode D2A to the return AC input line. When switch M1 is turned off, the energy stored in the inductor is released as current flows through the diode D1, charging up the output capacitor C and flowing through the load and returning to the AC main line return through the free-wheeling diode D2A.

In the negative half cycle, current flows through the inductor L storing energy when the transistor M2 is turned on by the SPS controller. The current path returns to the AC line through the diode D1A. When switch M2 is turned off, energy is released in the inductor as current flows through diode D2 charging the capacitor C and flowing through the load and returning to the AC line through the free-wheeling diode D1A.

As shown in FIG. 1, the two switches M1 and M2 can be driven simultaneously because of the presence of the freewheeling diodes D1A and D2A. When transistors M1 and M2 are on, the inductor charges through one of the transistors and the return path is through the freewheeling diode or body diode of the other transistor. This greatly simplifies the control process.

The PFC function requires controlling the current drawn from the main AC line and shaping it like the input voltage waveform. In order to accomplish this, the output voltage is sensed by the controller and the zero crossing of the AC line waveform is sensed by the zero crossing detector ZC. The sensed output voltage is used both to regulate the output voltage within the prescribed range and to provide power factor correction at the AC input. In particular, when the output voltage decreases (increased loading), the switches M1 and M2 are driven into conduction for longer periods of time by increasing the pulse width of the gate drive pulses, thereby storing more energy in the inductor for transfer to the output capacitor. If the load lightens and the output voltage increases, the transistors M1 and M2 are driven by a reduced pulse width gate drive signal to bring the output voltage back into regulation. By control of the PWM and the timing of the gate drive pulse in the half cycle, both the output regulation and the power factor can be regulated. In prior art circuits of this type, the input current is sensed, for example, by placing a resistor in the emitter circuits of the IGBTs to control the PFC. In the circuit of FIG. 1, current sensing is not necessary.

As is evident also from FIG. 1, there is one less diode drop than in the standard boost converter circuit with PFC, where there are always three diode drops, two in the bridge in each half cycle and in the boost diode. In the circuit of FIG. 1, there are only two diode drops in each half cycle, thus resulting in peak efficiency. Further, the IGBTs can be smaller since they conduct alternate half cycles even though they are driven simultaneously.

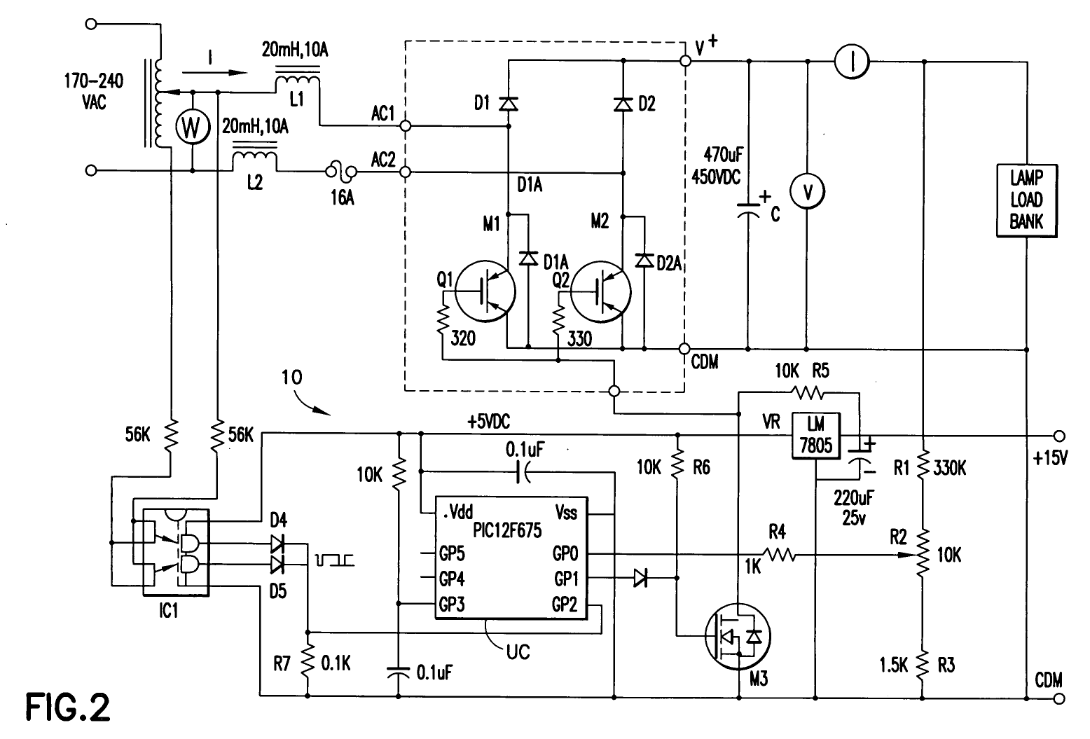

Turning now to FIG. 2, a bridgeless boost converter with SPS power factor correction employing digital control is shown and includes IGBTs M1 and M2, as in the circuit of FIG. 1, diodes D1, D1A, D2 and D2A, output capacitor C, input inductance L which is divided amongst two inductances L1 and L1A provided in the two AC input lines. The output of the converter circuit supplies DC power to the load.

The control circuit 10 includes a resistor divider comprising resistors R1, R2 and R3 coupled across the load. The voltage divider output is provided through a resistor R4 to the control chip C which in the illustrated embodiment is a PIC 12F675 microcontroller. A voltage regulator VR provides power for the microcontroller UC. The output of the microcontroller is provided at GP1 which controls an FET M3 which is turned on and off to provide appropriate gate drive pulses through the transistors M1 and M2. The drain of M3 is coupled through a resistor R5 to the 15 volt supply for the voltage regulator VR. The gate of the switch M3 is coupled to the output of the microcontroller GP1 through a diode D3 and coupled to the 5 volt output of the regulator VR through a resistor R6. Accordingly, when the output of the processor UC goes low, transistor M3 is turned off, generating a pulse at the gates of transistors M1 and M2. When GP1 goes high again, diode D3 is back biased, turning switch M3 on, and turning off the transistors Q1 and Q2. Accordingly, the time when the processor output is low determines the pulse width duration provided to the gates of the transistors M1 and M2.

Zero crossing detection is provided by an opto-coupler integrated circuit IC1 which determines when the input voltage is zero. The output of IC1 is provided to input GP2 of the microcontroller. IC1 is also coupled to the logic voltage supply line (+5V DC) and ground for power.

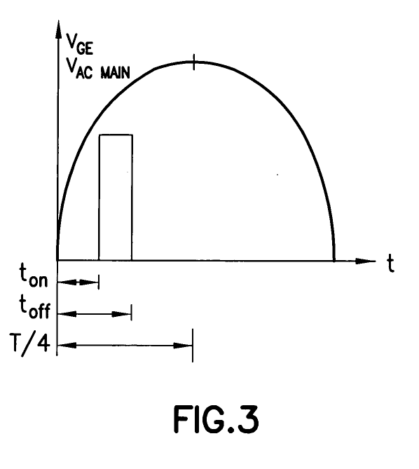

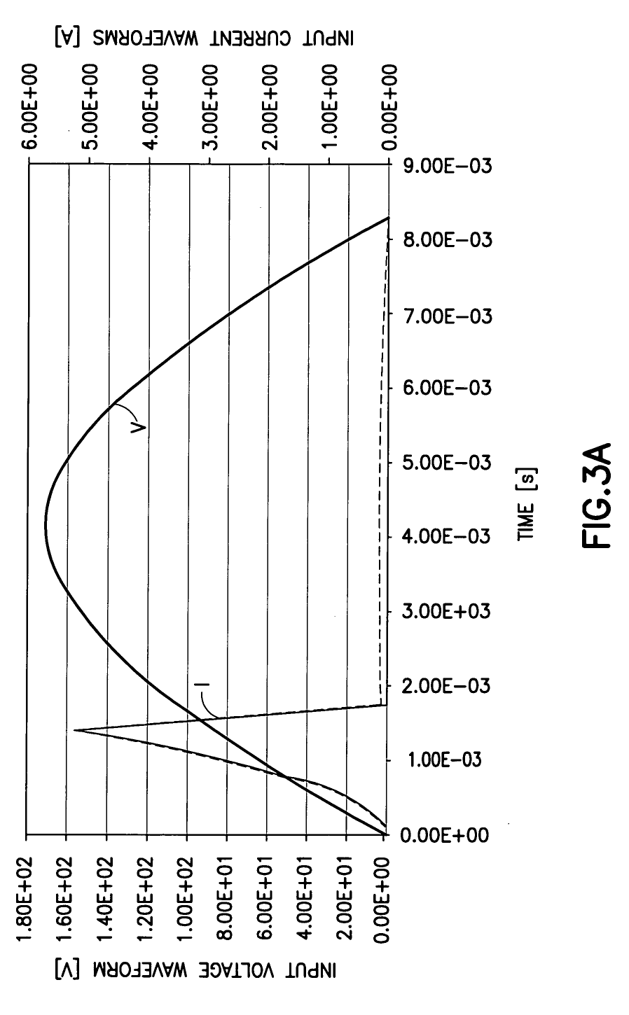

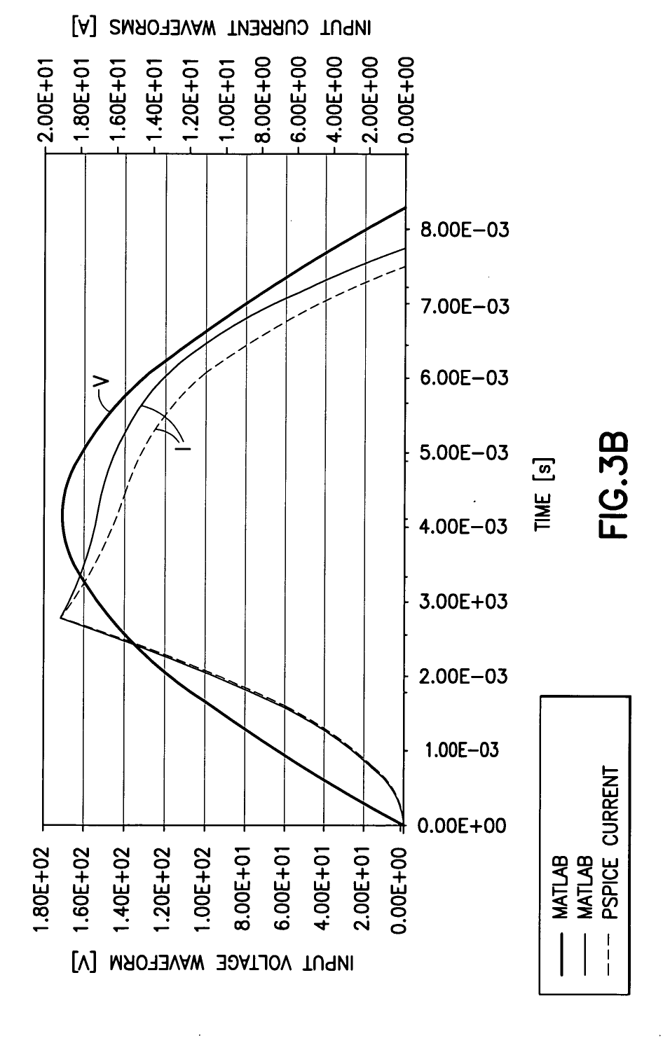

When the input voltage AC waveform is zero volts corresponding to a zero crossing of the input AC voltage, the output of the integrated circuit IC1 goes low, back biasing diodes D4 and D5, and thus driving the input GP2 to ground through a pull down resistor R7. When the input AC waveform is non-zero, the output IC1 will be high forward biasing diodes D4 and D5 and input GP2 will therefore be high as shown in FIG. 2 by the waveform adjacent to diodes D4 and D5. As described with reference to FIG. 3, the UC will issue an on-time signal a certain time after zero crossing detection and an off-time signal a certain time later after the zero crossing.

FIG. 3 shows the switch pulse timing driving the gates switches of M1 and M2. According to the invention, the switches M1 and M2 are controlled by single pulse control. The pulse does not begin until after the zero crossing as shown in FIG. 3 and the pulse width does not continue after the sine wave peak, that is ¼ of a period. FIG. 3 shows the switch timing. T-ON defines the time between the zero crossing of the AC voltage and the switch turn on. T-OFF determines the time to switch turn off with respect to the zero main AC voltage zero crossing.

FIGS. 3A and 3B show simulation examples of the operation of the circuit. At low power (FIG. 3A), the input current I is shown, corresponding to a small pulse duration. In this example t_{ON}=100 usec, t_{OFF}=1.4 ms, V=287 V_{OUT} and V_{IN}=120 Vrms.

In FIG. 3B, which shows a higher power example, it can be observed that the input current I closely matches and is in phase with the input AC voltage waveform for the entire half cycle. In the example, t_{ON}=100 u secs, t_{OFF}=2.8 msec, V_{OUT}=180V and V_{IN}=120 Vrms.

According to the invention, a program was written to generate a table of on-times and off-times to provide high power factors at various currents. This program was structured as follows:

First, a small time step was chosen (tₛₜₑₚ), not bigger than the microcontroller resolution over the chosen time interval (8 bit microcontroller on 1/(4·60) ms timeframe means tₛₜₑₚ≦16 μs). Then, a diagonal matrix was constructed, with same value in each column and tₙ₊₁=Tₙ+tₛₜₑₚ

$$P = [ \begin{matrix}{t}_{1} & {t}_{2} & {t}_{3} & {t}_{4} & ⋯ & {t}_{n} \\ & & & & & \vert \\ & {t}_{2} & {t}_{3} & {t}_{4} & ⋯ & \vert \\ & & & & & \vert \\ & & {t}_{3} & {t}_{4} & ⋯ & \vert \\ & & & & & \vert \\ & & & {t}_{4} & ⋯ & \vert \\ & & & & & \vert \\ & & & & & \vert \\ & & & & & {t}_{n}^{\vert}\end{matrix} ]$$

Subroutines were then run building several other matrixes (Irms, cosfi, input power) for each possible pulse, defined assigning row index to tₒₙ and column index to t_{off}

$${⌊ {t}_{on} , {t}_{off} ⌋}_{ij} = ⌊ {P}_{ii} , {P}_{ij} ⌋ i = 1 , n$$

$$j = i + 1 , n$$

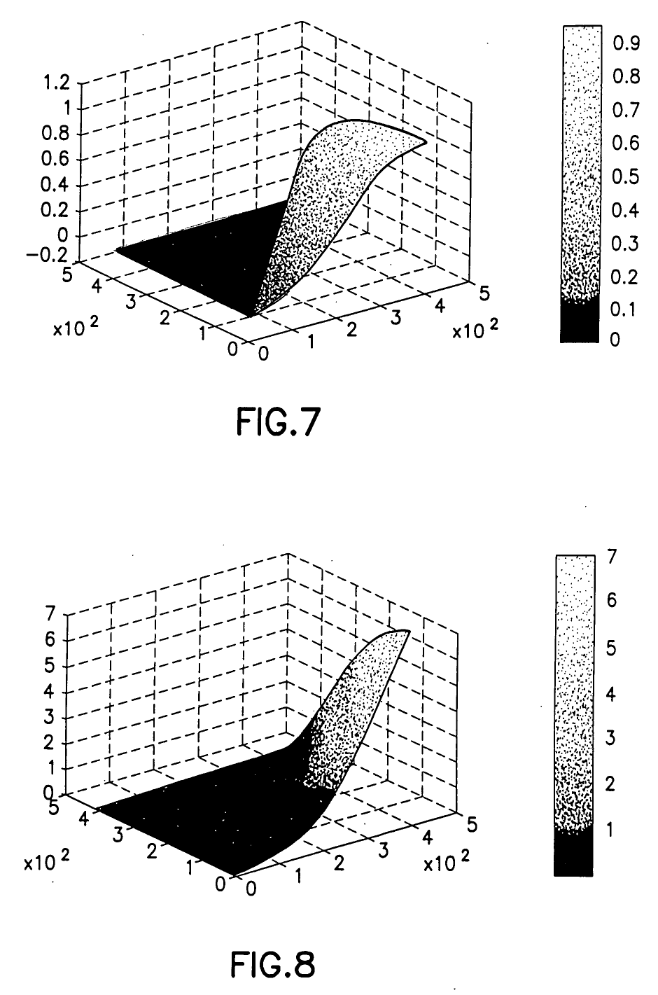

FIGS. 7 and 8 show the power factor as a function of T-ON and T-OFF and input RMS current as a function of T-ON and T-OFF.

From these figures, it is apparent that there are several possible pulses which can be used to obtain a high power factor greater than 0.85 and which allow a significant input current variation and thus regulation range.

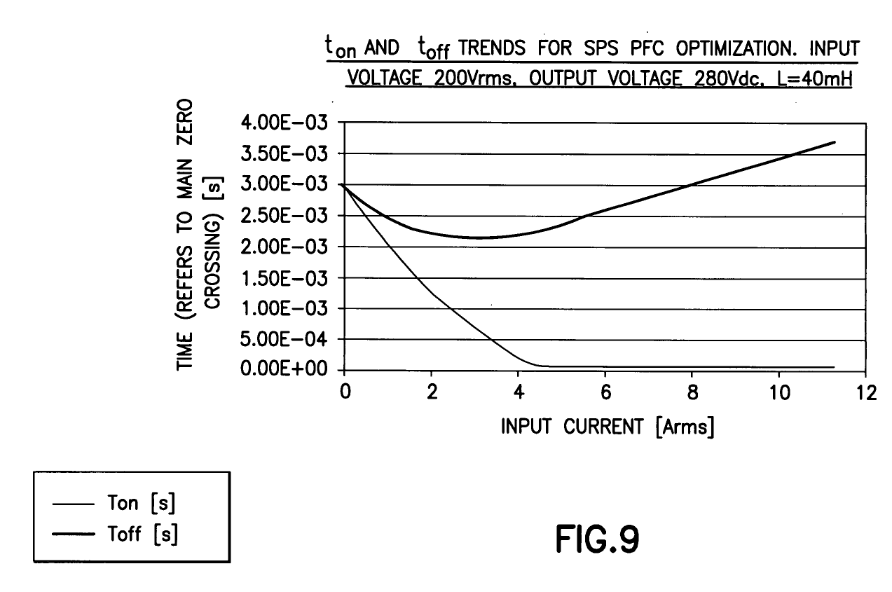

In order to have a wider regulation range at the maximum power factor, the program sorted out the minimum and maximum input current for pulses achieving power factors higher than 0.9. Afterward, this current range was subdivided equally and for each current value, the maximum power factor was chosen. The outcome of this operation is an optimal turn on and turn off time for each possible current value at given input and output voltage and inductor value. This is shown in FIG. 9. A table can be implemented in a digital memory based upon the graph shown in FIG. 9. Indexing the current values, the digital control can feed forward current and power factor having only a feedback based on output voltage. Moreover, the calculated timing curves allow linearizing the voltage integral across the inductor.

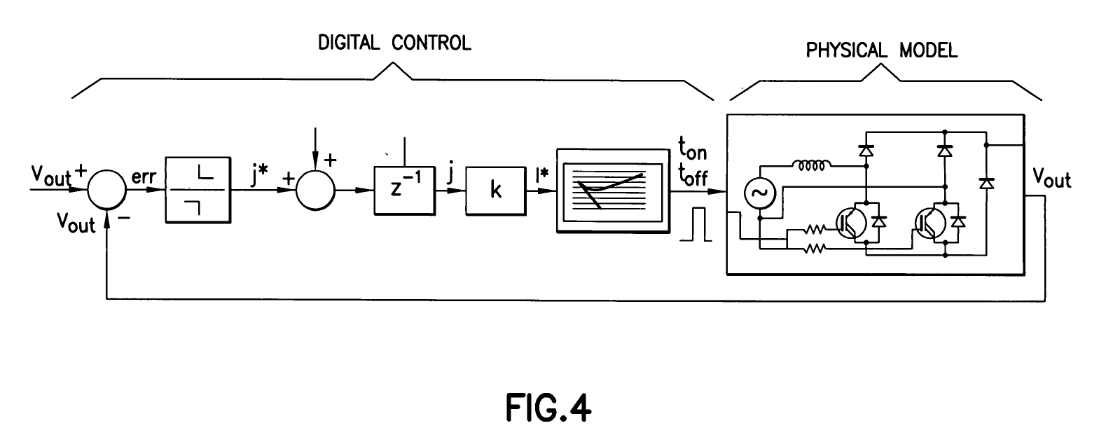

FIG. 4 shows the control system architecture for the digital controller implemented in the microprocessor of FIG. 2. As shown, the output voltage V_{OUT} is compared to the desired output voltage V_{OUT*} and an error signal is generated. The error signal is then used to address the look-up table T by the UC, which provides the pulse on and off times which are fed to switch M3 as a pulse and then to the gates of the switches M1 and M2.

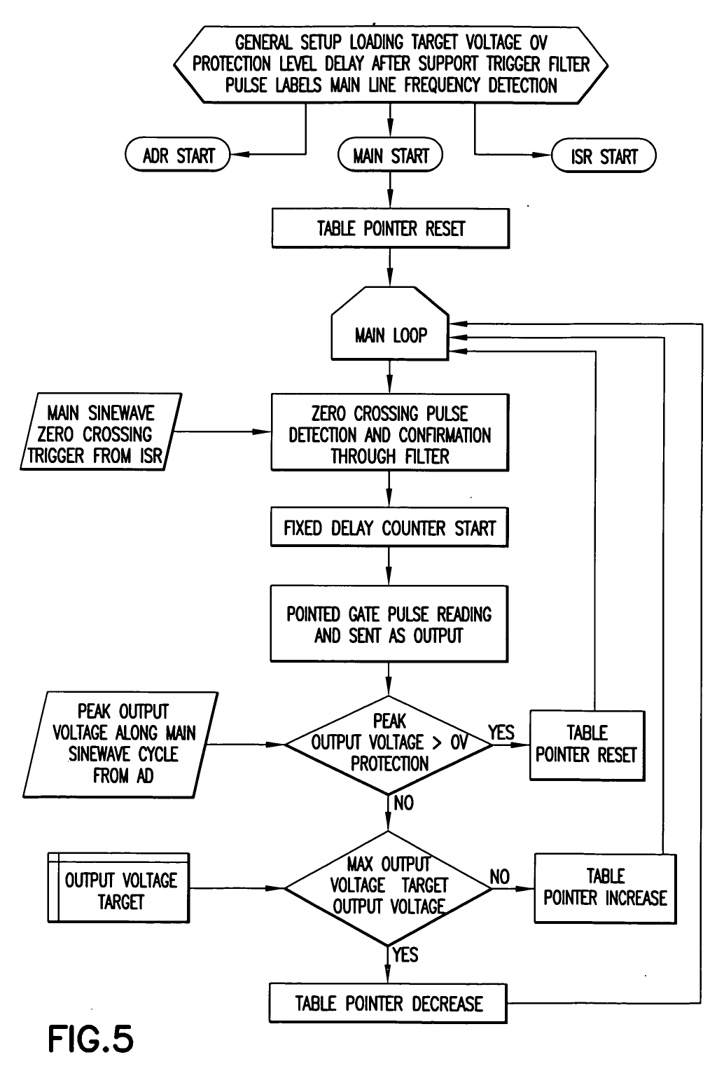

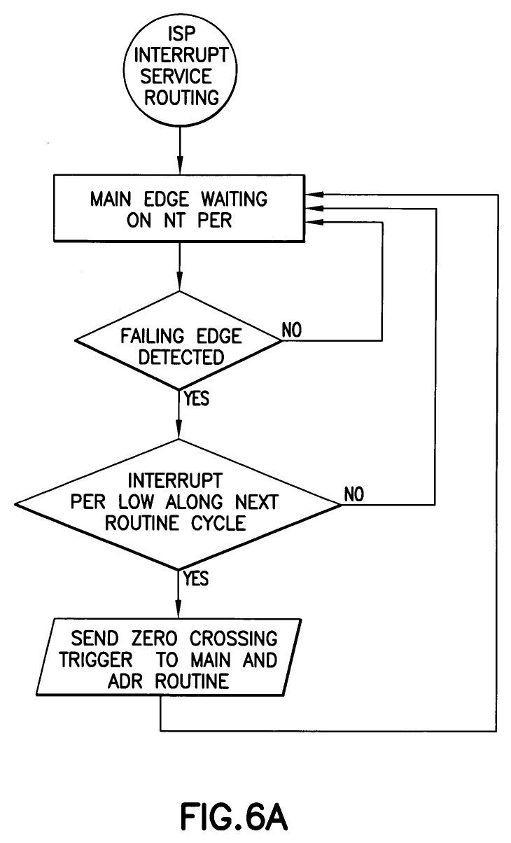

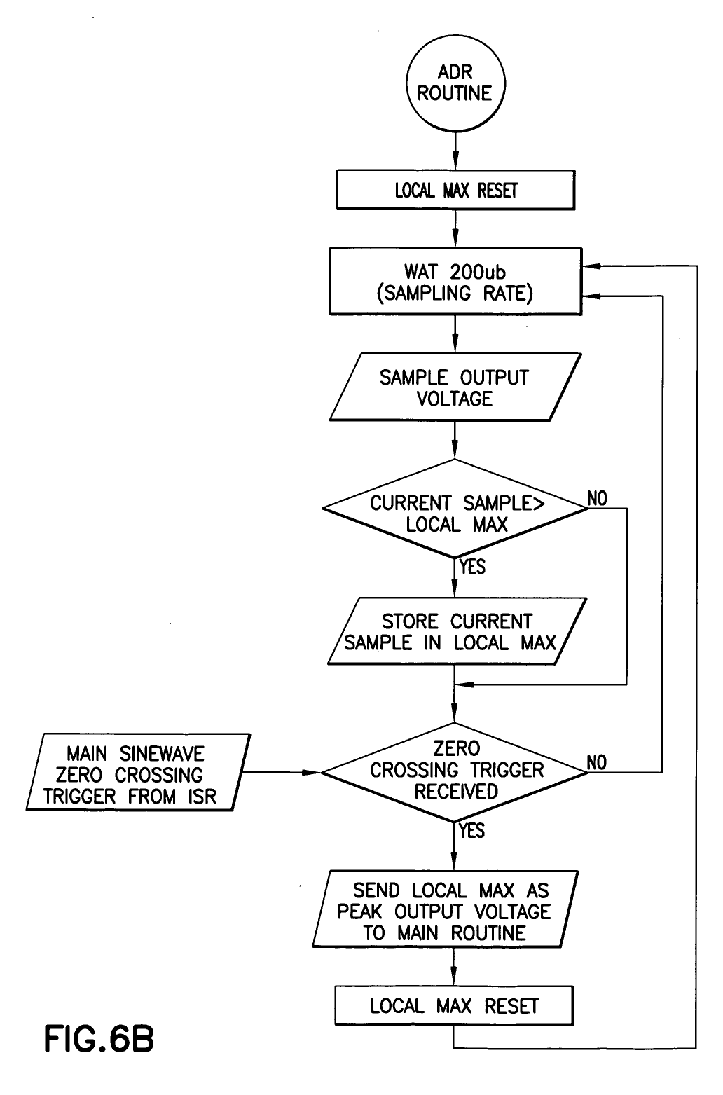

The control scheme can be implemented on a PIC12F675 microcontroller. The basic flow chart for the firmware is shown in FIG. 5. The flow chart of FIG. 5 is the main loop while the two flow charts of FIGS. 6A and 6B show subroutines for zero crossing trigger digital filtering and analog to digital conversion respectively.

At the start, shown in FIG. 5, a start up sequence detects the main AC frequency through the zero crossing input and addresses the proper timing table. Several parameters are loaded as constants. Two parallel routines comprising an ADR analog to digital routine (FIG. 6A) and ISR interrupt service routine (FIG. 6B) are then continuously running and provide proper inputs to the main program. In the ISR routine FIG. 6A, in order to avoid false triggering due to noise and disturbances, the digital filter properly acknowledges the zero crossing trigger pulse given by the opto coupler IC1 of FIG. 2

In the ADR routine FIG. 6B, the analog to digital converter samples the output voltage feedback through the resistor divider comprising resistors R1, R2 and R3 and stores the maximum value cycle by cycle, passing this value to the main routine as a feedback.

An initial fixed delay parameter is needed to properly compensate the external trigger pulse normally in advance because of the simple zero crossing circuitry.

The main routine is triggered by zero crossing detection and thus has a frequency of twice the main AC voltage. Before applying any pulse to the gates of the switches M1 and M2, the firmware checks any output voltage for an over voltage condition avoiding any further increase in output voltage by resetting the pulse sequence.

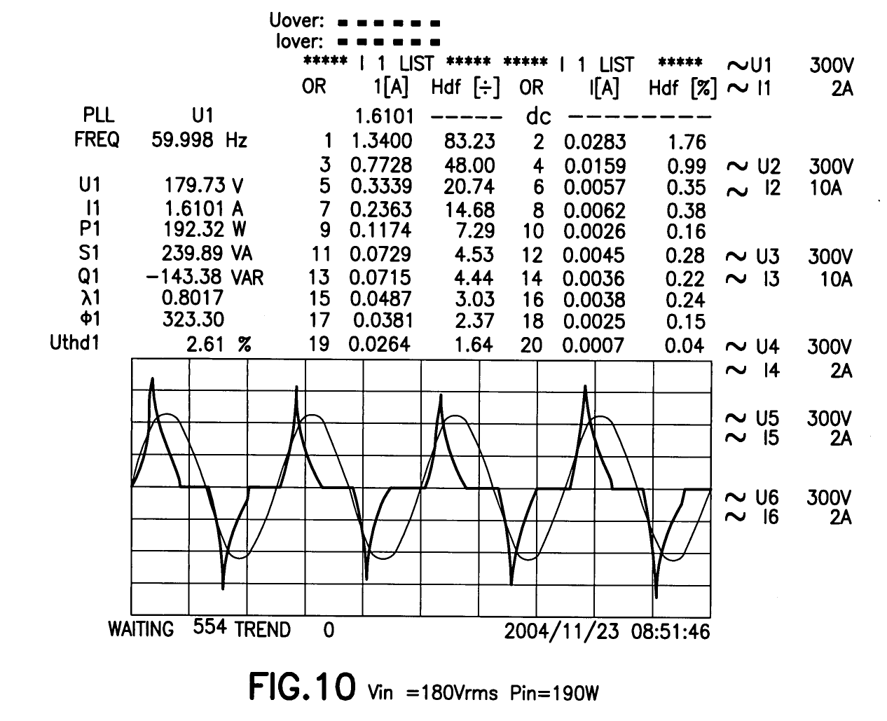

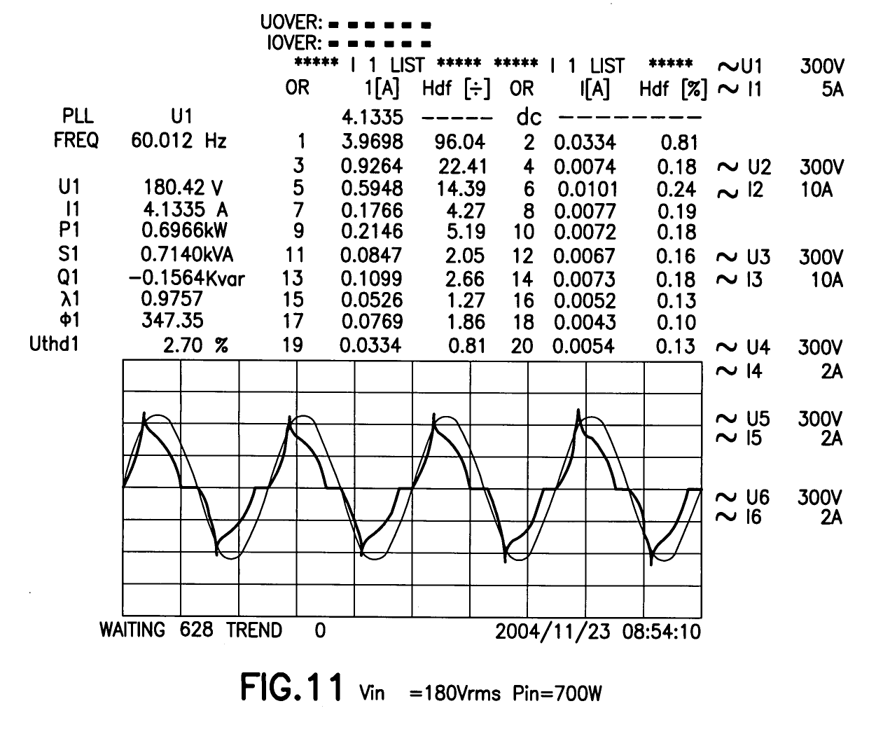

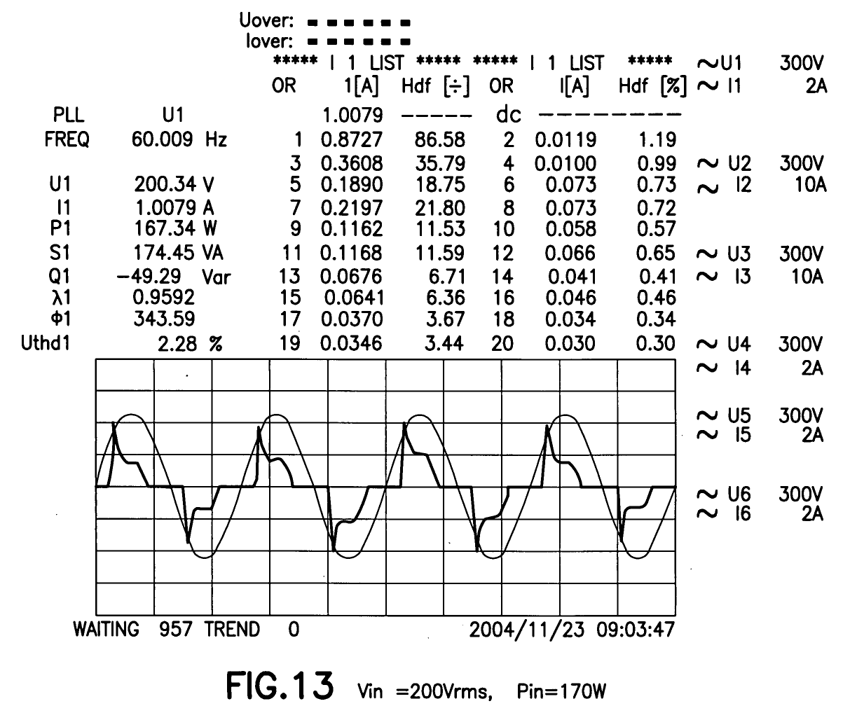

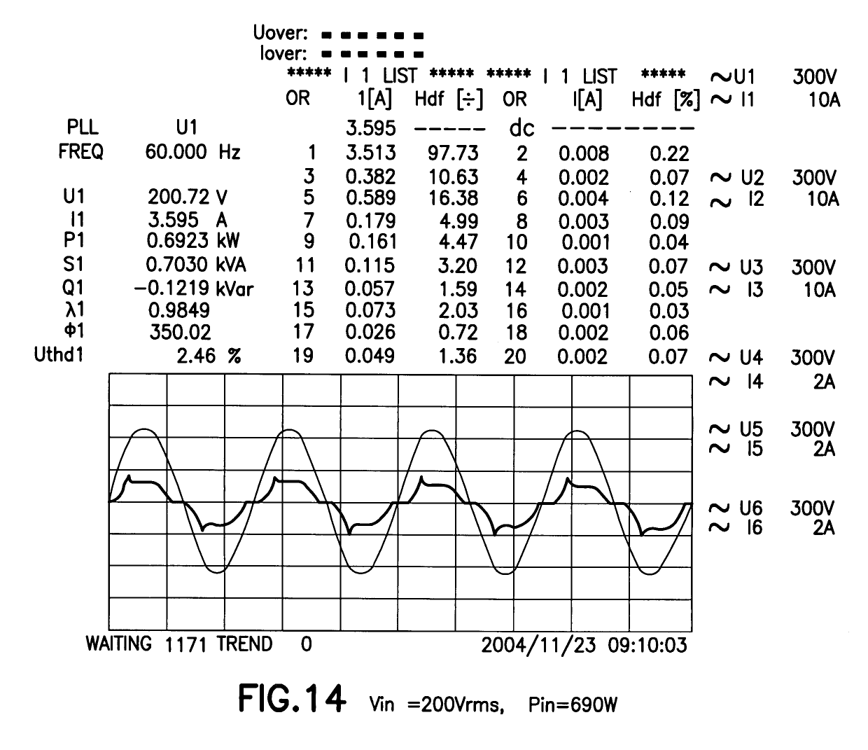

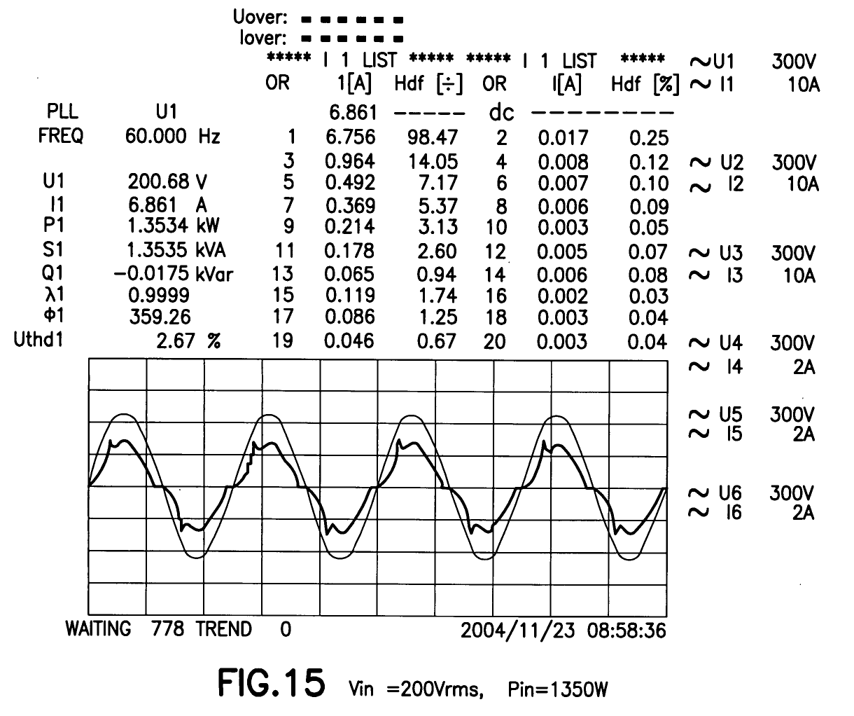

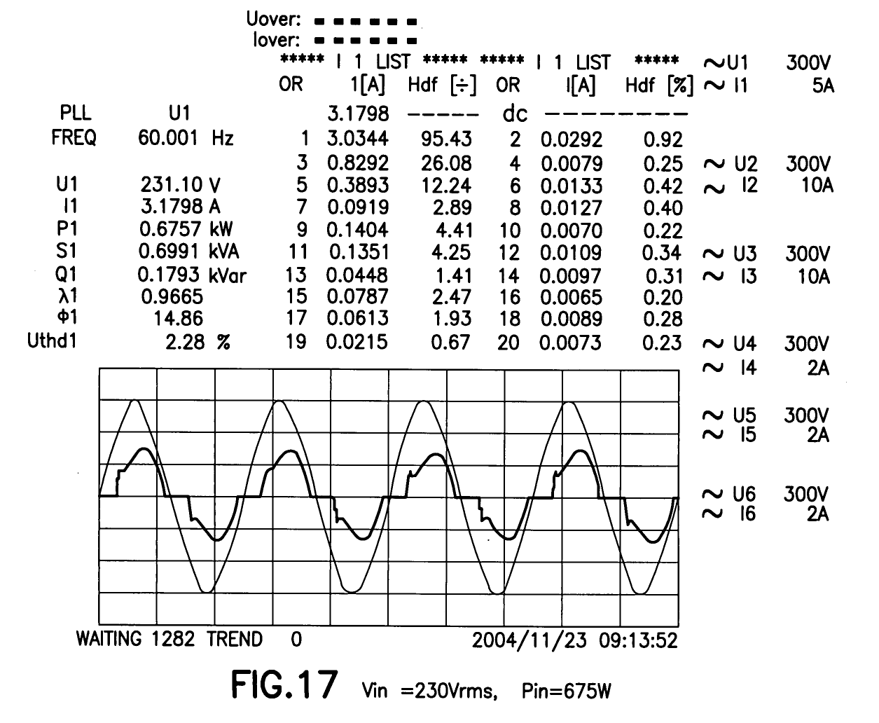

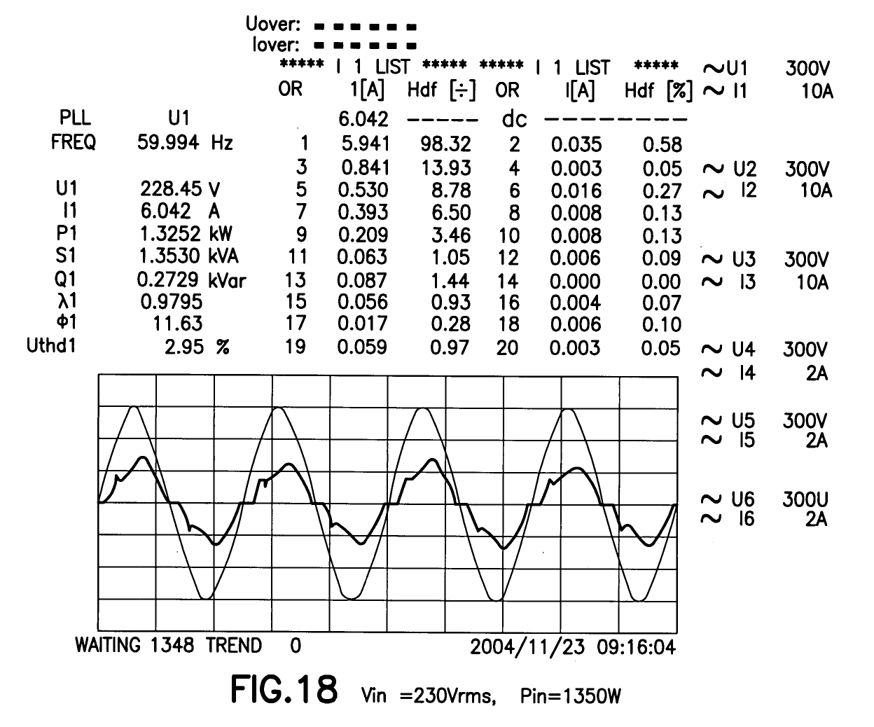

FIGS. 10-18 show the input waveforms, various input voltages and input powers. The parameters identified include

U1 RMS input voltage;

I1 RMS current;

P1 active power;

S1 apparent power;

Q1 reactive power;

λ1 power factor;

φ1 displacement angle; and

Uthd1 total harmonic distortion

The waveforms shown are input voltage and input current, three power levels, 180, 720 and 1400 watts, and three input main voltages, 180, 200 and 230 volts rms as shown. The output voltage is set to 280 volts in each case. With the exception of FIG. 10, the power factor λ1 in each case is well above 0.85.

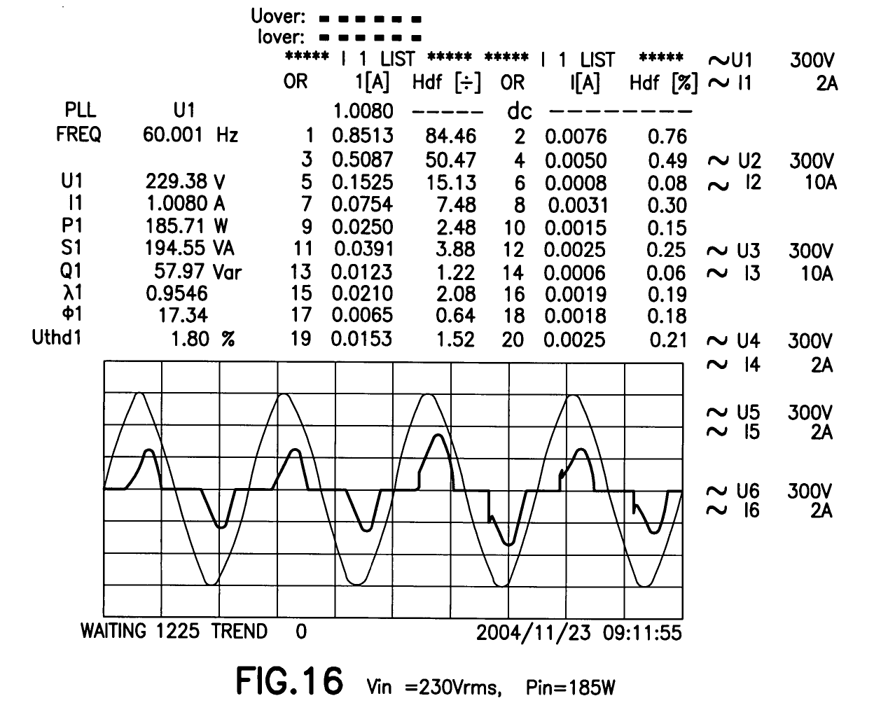

It is noticeable that there is a negative sign on reactive power for the lower voltage, almost unity power factor at medium voltage and a positive sign at higher voltage. This occurs because the calculated table is optimal for a 200 volt rms main line voltage. Below the optimization value the converter shows capacitive behavior while above the optimization value the circuit shows inductive behavior. This provides criteria on how to optimize the system. At 230 volt rms light load, the pulse is jittery, i.e., either zero pulse width or the smallest possible pulse width is selected. See FIG. 16.

At 180 volt rms low load, the power factor drops because of the relatively large pulse needed to boost the output voltage to 280 volts. This is the intrinsic limit in this kind of control. It is difficult to avoid because of the absence of any feedback suitable for identifying this particular condition. See FIG. 10.

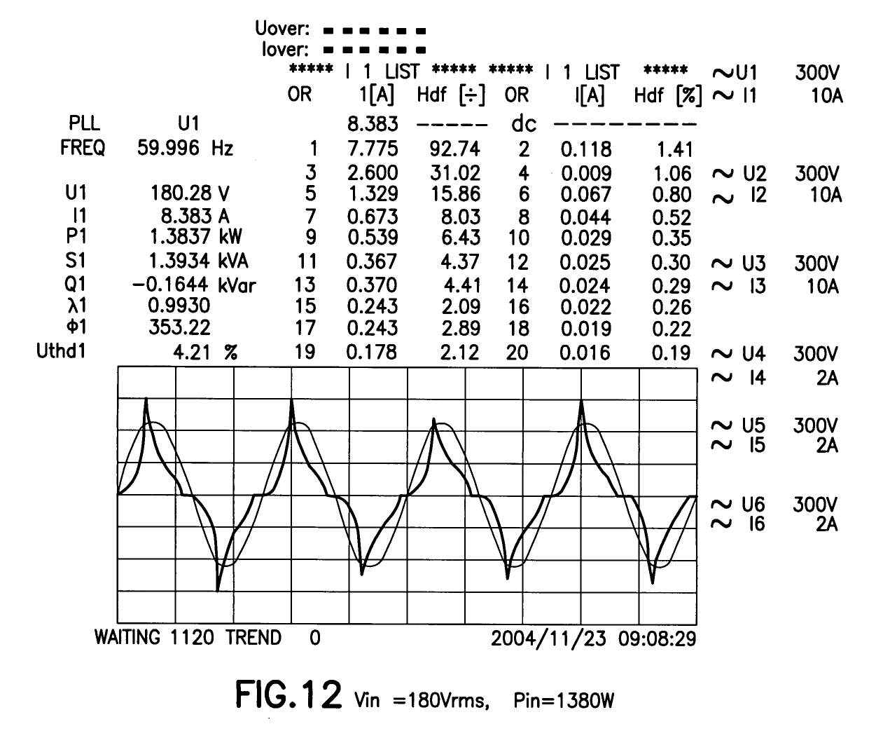

For 180 volt rms high load, see FIG. 12, the standard IC61000-3-2 is not satisfied because of a few harmonics over the limits as shown by Uthd1.

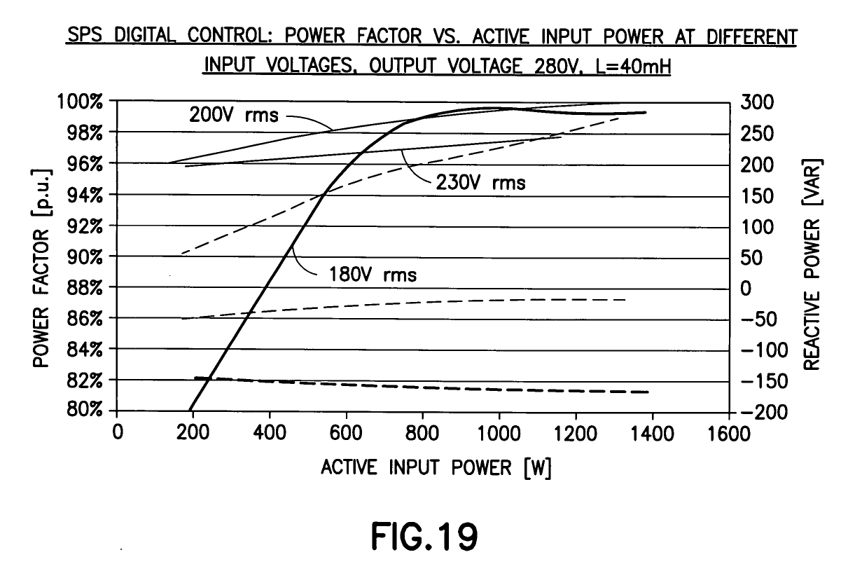

FIG. 19 summarizes the FIGS. 10-18 showing power factor versus active input power at different AC input voltages as shown and with the output voltage at 280 volts DC and with an input inductance of 40 millihenries.

The control system can achieve high power factors and stable DC output bus voltage complying with the harmonic rule IEC 61000-3-2 with one exception at high power, low AC input voltage condition as explained above, that is, at high power, 180 volt rms AC input (FIG. 12). With the AC input at 200 Vrms or higher, the power factor is always above 95% as shown in FIG. 19. It only drops below this level, as explained above, at the lower input voltage at low power levels.

Although the present invention has been described in relation to particular embodiments thereof, many other variations and modifications and other uses will become apparent to those skilled in the art. Therefore the present invention should be limited not by the specific disclosure herein, but only by the appended claims.

What is claimed is:

1. A boost type power supply circuit for providing a DC output voltage comprising:
first and second semiconductor switches coupled between respective input lines and a common connection, an AC input voltage from an AC source being supplied across the input lines;
first and second diodes coupled in series with respective ones of the switches;
third and fourth diodes coupled across respective ones of the switches in a free-wheeling relationship with the switches,
an inductance coupled in at least one of the input lines;
a controller for controlling the conduction times of the switches by providing a pulse width and phase modulated control signal to each of the switches;
whereby the controller turns on at least one of the switches during a positive half cycle of the AC voltage to allow energy storage in the inductance and turns off the at least one switch to allow the energy stored in the inductance to be supplied to an attached load through one of the first and second diodes and one of the third and fourth diodes; and
the controller turns on at least one of the switches during a negative half cycle of the AC voltage to allow energy storage in the inductance and turns off the at least one switch to allow the energy stored in the inductance to be supplied to the attached load through one of the first and second diodes and one of the third and fourth diodes; and wherein
the controller determines an on-time and an off-time of a pulse of the pulse width modulated control signal during each half cycle of the AC voltage based on at least one input without requiring sensing of the input current from the AC source;
the on-time and off-time of the pulse being controlled to regulate said output voltage and to provide power factor correction of said AC input voltage.

2. The circuit of claim 1, wherein the controller comprises a microprocessor and the microprocessor determines an on-time and off-time of a pulse of the pulse width modulated control signal during each half cycle of the AC voltage based on at least one input by accessing a memory storing a table of said on-times and off-times.

3. The circuit of claim 1, further comprising a detection circuit providing an input to said controller to determine a beginning of each half cycle of said AC voltage and wherein said on-times represent a first time period following said beginning of each half cycle and said off-times represent a second time period following said beginning of said half cycle, said pulse having a pulse width determined by the time difference between said on-time and said off-time; and said on-times and off-times being selected to provide power factor correction.

4. The circuit of claim 3, wherein said detection circuit to determine a beginning of each half cycle comprises a zero crossing voltage detection circuit.

5. The circuit of claim 4, wherein one of said inputs to said controller comprises an output of said zero crossing voltage detection circuit.

6. The circuit of claim 1, wherein the at least one input to said controller comprises a voltage related to the output voltage of said circuit, whereby the output voltage is regulated within a predefined regulation range by controlling said pulse width.

7. The circuit of claim 6, wherein the at least one input comprises a signal determining the beginning of each half cycle of said AC input voltage, said controller providing a pulse width modulated signal with said determined on-time and off-time to provide power factor correction of said AC input voltage.

8. The circuit of claim 2, wherein said controller comprises a memory having stored therein said on-times and off-times corresponding to a predefined range of power factor.

9. The circuit of claim 8, wherein said predefined range of power factor comprises a range between a predefined number less than 1 and 1.

10. The circuit of claim 8, wherein said memory comprises a look-up table.

11. The circuit of claim 1, wherein said third and fourth free-wheeling diodes comprise body diodes of respective one of said switches.

12. The circuit of claim 1, wherein said switches comprise bipolar transistors IGBTs, or FETs.

13. The circuit of claim 1, wherein said switches comprise FETs and said third and fourth diodes comprise body diodes of the FETs.

14. The circuit of claim 1, further comprising an output capacitor across which said output voltage is developed.

15. The circuit of claim 1, wherein said inductance comprises first and second inductors disposed in each of said input lines.

16. The circuit of claim 6, wherein the voltage related to the output voltage is developed across a voltage divider circuit.

17. The circuit of claim 2, wherein said memory has stored therein on-times and off-times for selected current values at specified input and output voltages and inductance values.

18. The circuit of claim 1, wherein said first and second switches are turned on and off substantially simultaneously.
